(19) United States
(12) Patent Application Publication
(10) Pub. No.: US 2025/0273949 A1
(43) Pub. Date: Aug. 28, 2025

(54) DETERMINATION APPARATUS, DETERMINATION METHOD, AND PROGRAM

(71) Applicant: NIPPON TELEGRAPH AND TELEPHONE CORPORATION, Tokyo (JP)

(72) Inventors: Yuji HIGUCHI, Tokyo (JP); Toru TANAKA, Tokyo (JP); Naomichi NAKAMURA, Tokyo (JP); Naoki HANAOKA, Tokyo (JP)

(21) Appl. No.: 18/858,066

(22) PCT Filed: Apr. 27, 2022
(86) PCT No.: PCT/JP2022/019183

§ 371 Date: Oct. 18, 2024

(51) Int. Cl. H02H 3/087; H02H 1/00

(52) U.S. Cl. CPC H02H 3/087; H02H 1/0007

(57) ABSTRACT

A determination apparatus includes: a cutoff unit configured to cut off and connect a power line connecting a DC power supply and a load device; a measurement unit configured to measure a current value flowing through the power line; and a determination unit configured to perform an operation of connecting and cutting off the power line a plurality of times using the cutoff unit and determine whether a predetermined event has occurred based on a change in the current value measured by the measurement unit in the plurality of times of operations.

### TECHNICAL FIELD

The present invention relates to a technique for controlling an inrush current in a DC power feeding system.

### BACKGROUND ART

In communication buildings, data centers, and the like, DC power feeding systems have been introduced to reduce power losses of the entire systems and achieve energy saving. For example, when load devices are newly connected to DC power feeding systems, large currents temporarily flow through power lines. Such a current is called an inrush current.

A DC power feeding system generally includes a circuit breaker, and when a large current flows, a current is cut off and a load device is disconnected from a power supply. In the case of a short-circuit current, it is necessary to immediately cut off the current. In the case of an inrush current, however, it is not preferable to cut off the current.

In the technique of the related art, in order to inhibit an inrush current, countermeasures to increase resistance of a circuit at any time and countermeasures to increase the resistance only after the circuit breaker is turned on by providing an inrush current inhibition circuit (a resistor or a thermistor) on the load device side have been used.

Also, there have been cases where countermeasures are taken to keep the circuit breaker from reacting to a transitional inrush current by setting an operation property (delay curve) in which the circuit breaker is not opened for a certain period of time through a delay operation after the circuit breaker is turned on.

### CITATION LIST

### Non Patent Literature

### Non Patent Literature 1:

https://www.cosel.co.jp/technical/qanda/a0015.html, retrieved on Apr. 17, 2022

### Non Patent Literature 2:

https://www.carlingtech.com/ja/trip-time-delay, retrieved on Apr. 17, 2022

### SUMMARY OF INVENTION

### Technical Problem

However, in the countermeasures taken using an inrush current inhibition circuit, a cost becomes large due to an increase in the number of components. Since a current flows at any time in a portion of an inrush current inhibition circuit, a loss occurs.

An inrush current inhibition circuit need not be provided if countermeasures to disable an operation of a circuit breaker for a certain period of time are taken. However, in countermeasures for disabling the operation of the circuit breaker for a certain period of time, when a short circuit or the like occurs inside a load device, the load device cannot be instantaneously disconnected. Therefore, the electric wire or the device may burn out. If it can be determined that an inrush current is generated rather than a short-circuit current, the operation of the circuit breaker can be disabled for a certain period of time.

The present invention has been devised in view of the foregoing circumstances, and an object of the present invention is to provide a technique for determining whether an inrush current has occurred in a DC power feeding system.

### Solution to Problem

According to the disclosed technique, a determination apparatus includes; a cutoff unit configured to cut off and connect a power line connecting a DC power supply and a load device; a measurement unit configured to measure a current value flowing through the power line; and a determination unit configured to perform an operation of connecting and cutting off the power line a plurality of times using the cutoff unit and determine whether a predetermined event has occurred based on a change in the current value measured by the measurement unit in the plurality of times of operations.

### Advantageous Effects of Invention

According to the disclosed technique, there is provided a technique for determining whether an inrush current has occurred in a DC power feeding system.

### BRIEF DESCRIPTION OF DRAWINGS

FIG. 1 is a diagram illustrating a configuration of a DC power feeding system.

FIG. 2 is a diagram illustrating a change in a current value with respect to an inrush current.

FIG. 3 is a diagram illustrating a change in a current value with respect to a short-circuit current.

FIG. 4 is a diagram illustrating a configuration of a DC power feeding system.

FIG. 5 is a diagram illustrating a configuration of a cutoff device 100.

FIG. 6 is a diagram illustrating a configuration of a control server 200.

FIG. 7 is a flowchart illustrating an operation of the system.

FIG. 8 is a flowchart illustrating an operation of the system.

FIG. 9 is a diagram illustrating a hardware configuration example of a device.

### DESCRIPTION OF EMBODIMENTS

Hereinafter, an embodiment of the present invention (the present embodiment) will be described with reference to the drawings. The embodiment described below is merely exemplary, and embodiments to which the present invention is applied are not limited to the following embodiment.

In the following description, turning off a circuit breaker (also referred to as a cutoff unit or a cutoff device) means cutting off an electric path (passage of a current). Turning off the circuit breaker may be expressed as opening the circuit breaker. Cutting off the electric path may be expressed as opening the electric path, cutting off a current, cutting off a power line, or the like.

Turning on the circuit breaker means enabling the electrical circuit to enter a connected state. Turning on the circuit breaker may be expressed as turning the circuit breaker on. Enabling the electric path to enter a connected state may be expressed as connecting a power line, closing the electric path, or the like.

In the following description, the present invention is used to determine an inrush current, but the present invention can be used to determine a predetermined event that is not limited to an inrush current.

### (Basic Configuration and Operation Principle of Embodiment)

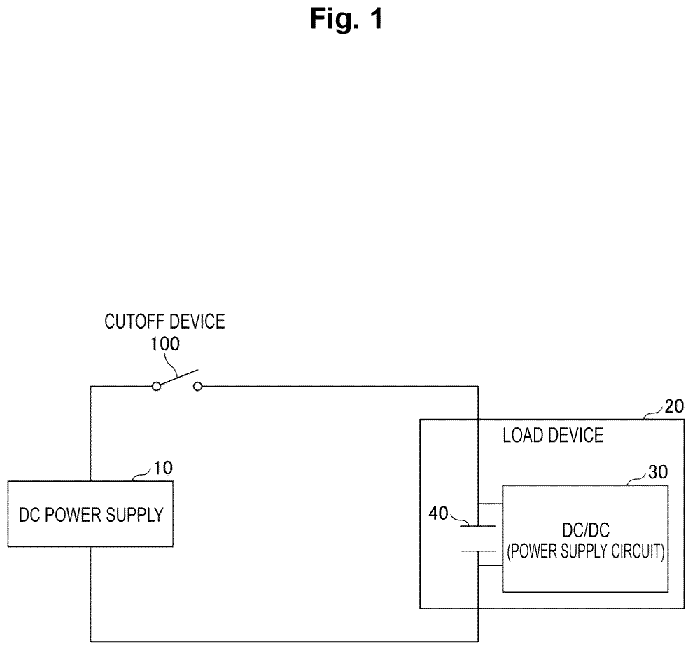

FIG. 1 illustrates a basic configuration of a DC power feeding system according to the present embodiment. As illustrated in FIG. 1, in the DC power feeding system according to the present embodiment, a DC power supply 10 and a load device 20 are connected by a power line, and a cutoff device 100 is provided on the power line.

The load device 20 includes a power supply circuit 30 (DC/DC converter) and a capacitor 40 (referred to as an X capacitor). In the present embodiment, the load device 20 includes the capacitor 40, which is exemplary. The capacitor 40 may be provided anywhere between a positive-side power line and a negative-side power line in the DC power feeding system.

The cutoff device 100 includes a cutoff unit 110 that opens and closes a power line (cutoff (OFF), connection (ON)). The cutoff unit 110 may be a mechanical type unit, a unit formed of a semiconductor, or an electromagnetic type unit.

It is assumed that a large current flows through the power line and the cutoff unit 110 cuts off the current (opens the electric path). At this time point, it is not clear whether a cause of the cutoff is an inrush current or a short-circuit current.

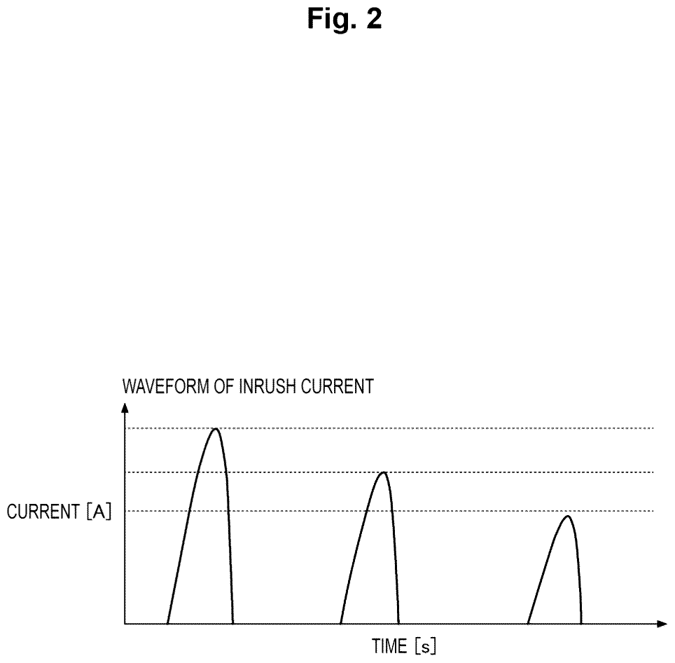

Accordingly, in the present embodiment, the cutoff unit 110 is turned on and off a plurality of times, and the capacitor 40 is intermittently charged in a pseudo manner. In a case where cutoff occurs due to the inrush current, the circuit is normal, and thus the current flowing through the power line decreases due to charging (accumulation of charges) in the capacitor 40. FIG. 2 illustrates a decrease in the current whenever the cutoff unit 110 is turned on.

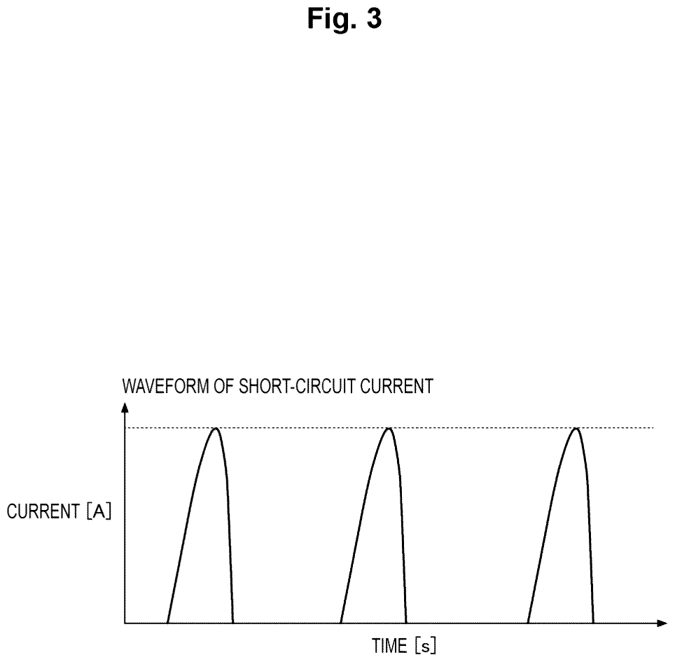

On the other hand, in the case where cutoff occurs due to a short circuit, resistance between a positive-side power line and a negative-side power line becomes very small. Therefore, there is no decrease in the current, as illustrated in FIG. 3.

As described above, by turning the cutoff unit 110 on and off a plurality of times, it is possible determine that an inrush current has occurred when the current decreases, and it is possible determine that a short circuit has occurred when the current does not decrease.

### (System Configuration)

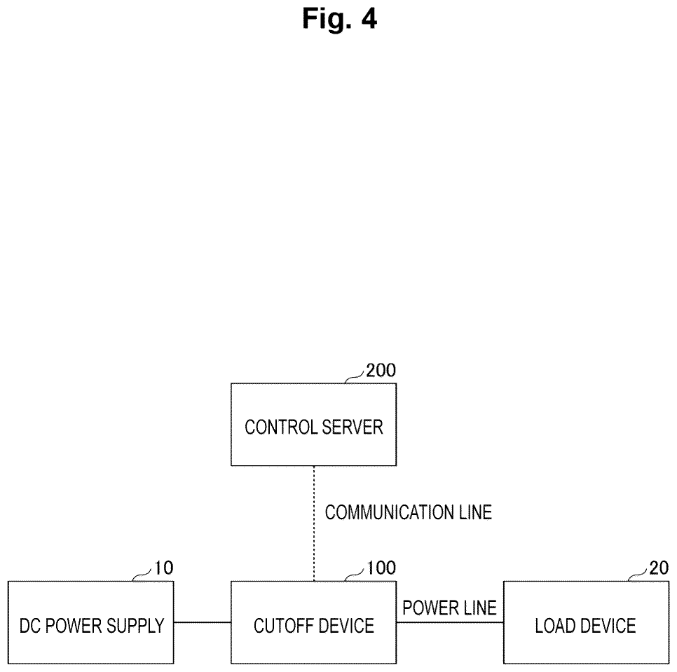

FIG. 4 illustrates an overall configuration example of the DC power feeding system according to the present embodiment. As illustrated in FIG. 4, this system includes the DC power supply 10, the cutoff device 100, the load device 20, and a control server 200.

The DC power supply 10 is connected to the load device 20 by a power line via the cutoff device 100. The control server 200 is connected to the cutoff device 100 via a communication line (network), and transmits an ON/OFF control signal to the cutoff device 100.

The cutoff device 100 monitors a current of the power line between the DC power supply 10 and the load device 20, and automatically cuts off the electric path (current path) when the current equal to or greater than a threshold flows through the power line. The cutoff device 100 determines “inrush current” and “short-circuit current” from the current value acquired from an internal current sensor, and disables a cutoff operation for a certain period of time when it is determined as the inrush current.

### (Device Configuration)

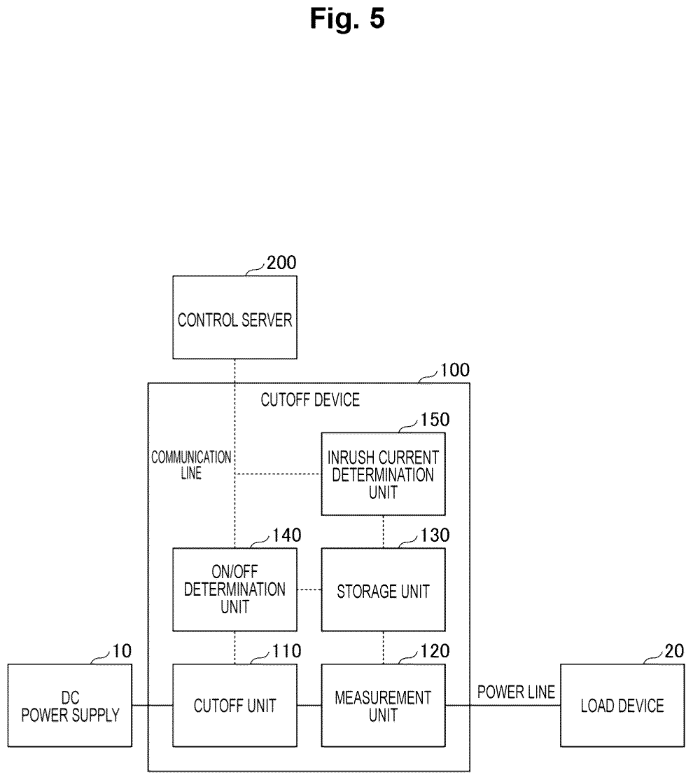

FIG. 5 is a diagram illustrating a configuration of the cutoff device 100 in the DC power feeding system. As illustrated in FIG. 5, the cutoff device 100 includes the cutoff unit 110, a measurement unit 120, a storage unit 130, an ON/OFF determination unit 140, and an inrush current determination unit 150. The “ON/OFF determination unit 140+inrush current determination unit 150” may be referred to as a “determination unit”.

The cutoff unit 110 opens and closes the electric path based on a determination result of the ON/OFF determination unit 140. The measurement unit 120 measures a value of the current flowing through the power line and transmits a measurement result to the storage unit 130.

The storage unit 130 stores a current value notified by the measurement unit 120. The ON/OFF determination unit 140 transmits a signal for opening and closing the electric path to the cutoff unit 110 based on the ON/OFF signal from the control server 200. Here, the ON signal is a signal for closing (connecting) the electric path, and the OFF signal is a signal for opening (cutting off) the electric path.

When the current value acquired from the storage unit 130 exceeds the threshold (or may be equal to or greater than the threshold), the ON/OFF determination unit 140 transmits a signal (cutoff signal) for cutting off the electric path to the cutoff unit 110. When the signal determined as the inrush current is received from the determination unit 150, the ON/OFF determination unit 140 stops transmitting the cutoff signal based on the threshold for a certain period of time (a period of a predetermined time length). That is, an overcurrent cutoff function in the cutoff unit 110 is stopped.

The inrush current determination unit 150 determines “inrush current” and “short-circuit current” from the current value for each number of times of turn-on acquired from the storage unit 130. In the case of the inrush current, a signal indicating that the inrush current is determined is transmitted to the ON/OFF determination unit 140.

The cutoff device 100 may be one physical device or a plurality of physical devices. For example, the “cutoff unit 110+measurement unit 120” and the “storage unit 130+ON/OFF determination unit 140+inrush current determination unit 150” may be separate devices. A device including the inrush current determination unit 150 may be referred to as an “inrush current determination apparatus”. A device including the inrush current determination unit 150 and the ON/OFF determination unit 140 may be referred to as an “inrush current determination apparatus”. The cutoff device 100 may include an output unit that outputs determination results of the “inrush current” and the “short-circuit current”.

The control server 200 may include, for example, a storage unit 130 and an inrush current determination unit 150. In this case, the cutoff device 100 includes the cutoff unit 110, the ON/OFF determination unit 140, and the measurement unit 120. The control server 200 may be referred to as an “inrush current determination apparatus”.

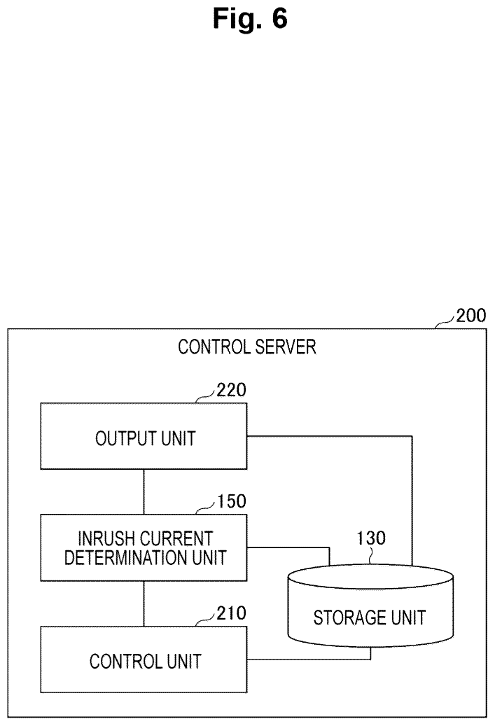

FIG. 6 illustrates a configuration example in which the control server 200 includes the storage unit 130 and the inrush current determination unit 150. As illustrated in FIG. 6, the control server 200 in this case includes the storage unit 130, the inrush current determination unit 150, a control unit 210, and an output unit 220. The control unit 210 transmits an ON/OFF control signal to the cutoff device 100, receives a current value from the measurement unit 120 of the cutoff device 100, and stores the received current value in the storage unit 130. The control unit 210 transmits a “signal indicating that an inrush current is determined” from the inrush current determination unit 150 to the cutoff device 100. The function of the inrush current determination unit 150 has been described above. The “inrush current determination apparatus” may be referred to as a “determination apparatus”.

### Operation Example

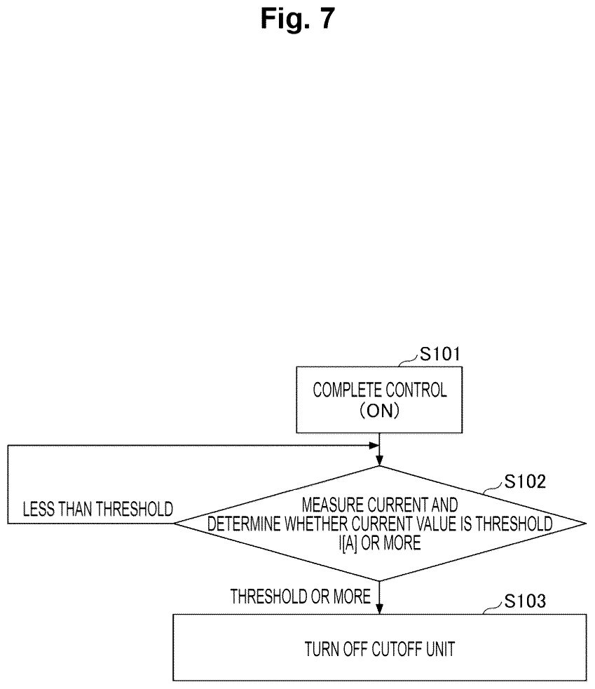

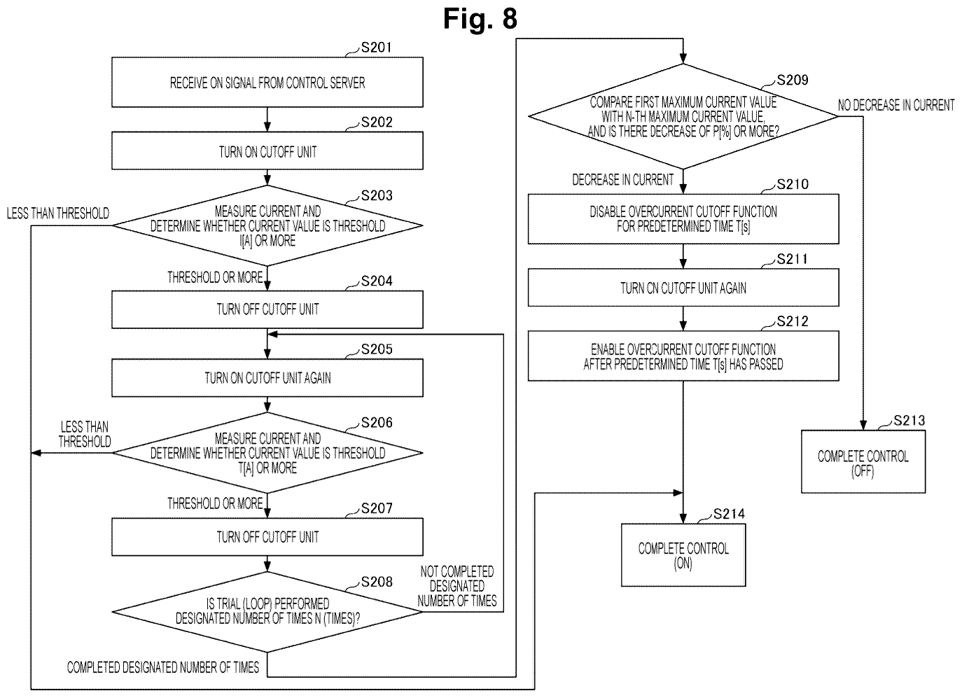

An operation example in the system configuration illustrated in FIG. 5 will be described with reference to the flowcharts of FIGS. 7 and 8.

In S101 of FIG. 7, it is assumed that a certain control is completed and the cutoff unit 110 is turned on. That is, the electric path is in a connected state.

In S102, the measurement unit 120 measures a current flowing through the power line, and the ON/OFF determination unit 140 determines whether the current value is equal to or greater than the threshold. If the current value is not equal to or greater than the threshold, S102 is repeated.

When the current value is equal to or greater than the threshold, in S103, the ON/OFF determination unit 140 transmits a signal for instructing cutoff of the electric path to the cutoff unit 110, and the cutoff unit 110 opens the electric path. That is, the cutoff unit 110 is turned off.

When the electric path is opened in S103 of FIG. 7, a flow of FIG. 8 is executed to determine the reason (the reason why a large current flows), and control is performed according to a determination result.

In S201 of FIG. 8, the ON/OFF determination unit 140 receives the ON signal from the control server 200.

In S202, the ON/OFF determination unit 140 turns on the cutoff unit 110. As a result, since the electric path enters a connected state, a current flows through the power line.

In S203, the measurement unit 120 measures the current and stores a current value of a measurement result in the storage unit 130. The ON/OFF determination unit 140 determines whether the current value is equal to or greater than the threshold.

When the determination result in S203 is “less than the threshold”, the process proceeds to S214, the control is completed, and the cutoff unit 110 continues to be in the ON state.

When the determination result in S203 is “equal to or greater than the threshold”, the process proceeds to S204, and the ON/OFF determination unit 140 turns off the cutoff unit 110 to open the electric path. In S205, the ON/OFF determination unit 140 turns on the cutoff unit 110 again. As a result, since the electric path enters a connected state, a current flows through the power line.

In S206, the measurement unit 120 measures the current and stores the current value of the measurement result in the storage unit 130. The ON/OFF determination unit 140 determines whether the current value is equal to or greater than the threshold.

When the determination result in S206 is “less than the threshold”, the process proceeds to S214, the control is completed, and the cutoff unit 110 continues to be in the ON state.

When the determination result in S206 is “equal to or greater than the threshold”, the process proceeds to S207, and the ON/OFF determination unit 140 turns off the cutoff unit 110 to open the electric path.

When the determination result is “less than the threshold” in S203 and S206, the ON/OFF determination unit 140 (or the inrush current determination unit 150) may determine that the inrush current has occurred and output the determination result.

In S208, the ON/OFF determination unit 140 determines whether a trial is performed designated number of times (N times). When the trial of the designated number of times is completed, the process proceeds to S209. When the trial of the designated number of times is not completed, the process from S205 is executed again.

For example, assuming that the process starts from S201, the number of times N is the number of times the cutoff unit 110 is turned on, and N=2, the designated number of times is completed at the time of the first S207, and thus the process proceeds to S209.

In S209, the inrush current determination unit 150 reads the measurement result stored in the storage unit 130, compares a first current value with an N-th current value, and determines whether there is a decrease of P % or more. P is a predetermined threshold. Here, it is determined whether there is a decrease of P % or more, but this is exemplary. In addition, for example, it may be determined whether a value obtained by subtracting the first current value from the Nth current value is a certain threshold or more.

In S209, when there is no decrease in the current equal to or greater than the threshold (the case illustrated in FIG. 3), the inrush current determination unit 150 determines that the large current equal to or greater than a threshold I is a short-circuit current, completes the control in S213, and continues the opening of the electric path.

In S209, when there is a decrease in the current equal to or greater than the threshold (the case illustrated in FIG. 2), the inrush current determination unit 150 determines that the large current equal to or greater than the threshold I is an inrush current, and the process proceeds to S210.

In S210, the inrush current determination unit 150 transmits a signal indicating that an inrush current has occurred to the ON/OFF determination unit 140. The ON/OFF determination unit 140 that has received the signal disables the overcurrent cutoff function for a predetermined time T. That is, even when the current value equal to or greater than the threshold is detected, the ON/OFF determination unit 140 does not turn off the cutoff unit 110 which is in the ON state.

In S211, the ON/OFF determination unit 140 turns on the cutoff unit 110 to cause an electric circuit to enter a connection state.

When the time T has passed after the overcurrent cutoff function is disabled in S210, the ON/OFF determination unit 140 enables the overcurrent cutoff function and completes the control in S214. In S210, since it is known that the short-circuit current has not occurred, the overcurrent cutoff function is disabled. Therefore, there is no problem.

### (Hardware Configuration Example)

The above-described inrush current determination apparatus (which may be referred to as a determination apparatus) can be implemented, for example, by causing a computer to execute a program. This computer may be a physical computer or may be a virtual machine on a cloud.

That is, the inrush current determination apparatus can be implemented by executing a program corresponding to a process performed by the inrush current determination apparatus using hardware resources such as a CPU and a memory built in the computer. The foregoing program can be stored and distributed by being recorded in a computer-readable recording medium (portable memory or the like). The foregoing program can also be provided via a network such as the Internet or an electronic mail.

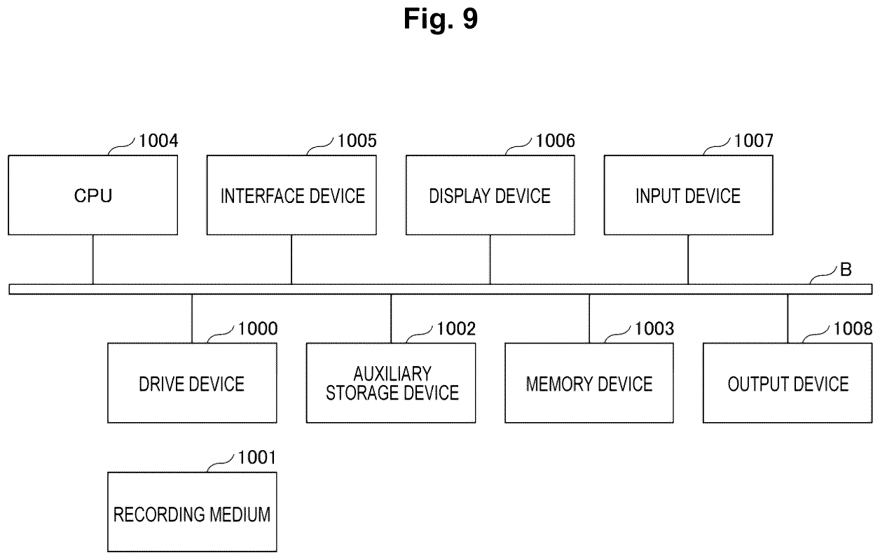

FIG. 9 is a diagram illustrating a hardware configuration example of the foregoing computer. The computer in FIG. 9 includes a drive device 1000, an auxiliary storage device 1002, a memory device 1003, a CPU 1004, an interface device 1005, a display device 1006, an input device 1007, an output device 1008, and the like which are connected to each other via a bus BS.

The program implementing a process in the computer is provided by, for example, a recording medium 1001 such as a CD-ROM or a memory card. When the recording medium 1001 storing the program is set in the drive device 1000, the program is installed on the auxiliary storage device 1002 from the recording medium 1001 via the drive device 1000. However, the program is not necessarily installed from the recording medium 1001, and may be downloaded from another computer via a network. The auxiliary storage device 1002 stores the installed program and also stores necessary files, data, and the like.

When an instruction to start a program is given, the memory device 1003 reads the program from the auxiliary storage device 1002 and stores the program. The CPU 1004 implements a function related to the light touch retaining device 100 according to the program stored in the memory device 1003. The interface device 1005 is used as an interface for connection to a network, various measurement devices, a motion intervention device, or the like. The display device 1006 displays a graphical user interface (GUI) or the like according to the program. The input device 1007 includes a keyboard and a mouse, buttons, or a touchscreen and is used to input various operation instructions. The output device 1008 outputs a calculation result.

### Effects of Embodiments

The technique according to the present embodiment can reduce the cost since an inrush current inhibition circuit is unnecessary. Since a short-circuit current and an inrush current can be determined without disabling the overcurrent cutoff function, a possibility of wiring damage can be eliminated.

### (Supplements)

The present specification discloses at least the following determination apparatus, determination method, and program.

### (Supplement 1)

A determination apparatus including:
a cutoff unit configured to cut off and connect a power line connecting a DC power supply and a load device;
a measurement unit configured to measure a current value flowing through the power line; and
a determination unit configured to perform an operation of connecting and cutting off the power line a plurality of times using the cutoff unit and determine whether a predetermined event has occurred based on a change in the current value measured by the measurement unit in the plurality of times of operations.

### (Supplement 2)

The determination apparatus according to Supplement 1, wherein
the determination unit determines that an inrush current has occurred when the current value decreases in the plurality of times of operations, and determines that a short-circuit current has occurred when the current value does not decrease in the plurality of times of operations.

### (Supplement 3)

The determination apparatus according to Supplement 1, wherein
the determination unit disables an overcurrent cutoff function in the cutoff unit when determination unit determines that an inrush current has occurred based on the change in the current value.

### (Supplement 4)

A determination method executed by a computer in a system including a cutoff unit that cuts off and connects a power line connecting a DC power supply and a load device, and a measurement unit that measures a current value flowing through the power line, the determination method including:
performing an operation of connecting and cutting off the power line a plurality of times using the cutoff unit and determining whether a predetermined event has occurred based on a change in the current value measured by the measurement unit in the plurality of times of operations.

### (Supplement 5)

A non-transitory storage medium that stores a program causing a computer to function as the determination unit in the determination apparatus according to any one of Supplements 1 to 3.

Although the present embodiment has been described above, the present invention is not limited to such a specific embodiment, and various modifications and changes can be made within the scope of the gist of the present invention described in the claims.

### REFERENCE SIGNS LIST

10 DC power supply
20 Load device
30 Power supply circuit
40 Capacitor
100 Cutoff device
110 Cutoff unit
120 Measurement unit
130 Storage unit
140 ON/OFF determination unit
150 Inrush current determination unit
200 Control server
210 Control unit
220 Output unit
1000 Drive device
1001 Recording medium
1002 Auxiliary storage device
1003 Memory device
1004 CPU
1005 Interface device
1006 Display device
1007 Input device
1008 Output device

1. A determination apparatus comprising:
a memory; and
a processor coupled to the memory and configured to:
cut off and connect a power line connecting a DC power supply and a load device;
measure a current value flowing through the power line; and
perform an operation of connecting and cutting off the power line a plurality of times-using the cutoff unit and determine whether a predetermined event has occurred based on a change in the current value measured in the plurality of times of operations.

2. The determination apparatus according to claim 1, wherein
the processor is configured to determine that an inrush current has occurred when the current value decreases in the plurality of times of operations, and to determine that a short-circuit current has occurred when the current value does not decrease in the plurality of times of operations.

3. The determination apparatus according to claim 1, wherein
the processor is configured to disable an overcurrent cutoff function when the processor determines that an inrush current has occurred based on the change in the current value.

4. A determination method executed by a computer in a system including: a memory; and a processor coupled to the memory and configured to: cut off and connect a power line connecting a DC power supply and a load device, and measure a current value flowing through the power line, the determination method comprising:
performing an operation of connecting and cutting off the power line a plurality of times and determining whether a predetermined event has occurred based on a change in the current value measured in the plurality of times of operations.

5. A non-transitory computer-readable recording medium storing a program causing a computer to perform the method of claim 4.
